(19) United States
(12) Patent Application Publication
(10) Pub. No.: US 2012/0328826 A1
(43) Pub. Date: Dec. 27, 2012

(54) COMPOSITE BOARD FORMED BY METAL SUBSTRATE CONNECTED TO DECORATIVE OUTER LAYER AND METHOD FOR MANUFACTURING THE SAME

(76) Inventor: Ming-Jen Hsieh, Taiping City (TW)

(21) Appl. No.: 13/582,719

(22) PCT Filed: Mar. 5, 2010
(86) PCT No.: PCT/CN10/00271

§ 371 Date: Sep. 4, 2012

(51) Int. Cl. B32B 3/24; B32B 37/12; B32B 7/12; B32B 33/00; B32B 15/06

(52) U.S. Cl. 428/134; 156/228

(57) ABSTRACT

A composite board formed by a metal substrate connected to a decorative outer layer and a method for manufacturing the same are revealed. A first thermoplastic rubber (TPR) adhesive layer synthesized by butadiene-styrene block copolymer and hydrocarbon petroleum resin is disposed on the metal substrate by hot press. A part of the first TPR adhesive layer with a thickness of 40-50 μm is infiltrated into micro concave holes on the metal substrate. A second TPR adhesive layer is attached to the decorative outer layer by a roller without being infiltrated into micro holes on the decorative outer layer. Then the metal substrate and the decorative outer layer are treated by hot press laminating to form an integral composite board due to the first and the second TPR adhesive layers connected tightly. The composite board is deep processed to produce a housing with good strength and beautiful appearance.

### BACKGROUND OF THE INVENTION

1. Fields of the invention

The present invention relates to a composite board formed by a metal substrate connected to a decorative outer layer and a method for manufacturing the same. A first thermoplastic rubber (TPR) adhesive layer and a second TPR adhesive layer are respectively attached to a metal substrate and a decorative outer layer. Each TPR adhesive layer is a thermoplastic rubber layer synthesized by butadiene-styrene block copolymer and hydrocarbon petroleum resin. Then the decorative outer layer and the metal substrate are treated by a hot press laminating process to connect to each other by the first and the second adhesive layers on their surfaces attached to each other. Thus an integral composite board is formed and the composite board can be used to produce a housing for electronics.

2. Descriptions of Related Art

There are various electronics available on the market including computers, notebook computers, communication produces such as mobile phones, consumer products, etc. They all include a housing covering all the components therein. The structure of the housing varies according to the design requirements of the product. According to materials for a base of the housing, the housing includes two types-a plastic housing and a metal housing.

The plastic housing with a decorative outer surface is generally produced by in-mold decoration process (IMD). A substrate that is 3-dimensional and printed with figures such as a plastic film is mounted into a mold. The substrate (plastic film) is called IMD film hereafter. Then thermoplastic resin is injected by injection molding technique to form a base of the housing on the rear side of the IMD film and the base is called resin base. The resin base and the IMD film are connected to form an integrated plastic housing. The IMD film is fixed and connected to the outer surface of the resin base to form a permanent device. The IMD film is used as a decorative outer surface for the plastic housing, a protective surface for the plastic housing or both. Moreover, the protective surface for the can also be temporarily fixed on the outer surface of the resin base to form a temporary device. After completing the production, the IMD film is peeled off. The printed figures on the IMD film are transferred to or embossed on the outer surface of the resin base to form a decorative outer surface of the plastic housing.

There are many techniques related to the structure design and manufacturing method of the plastic housing mentioned above.

Refer to U.S. Pat. No. 3,654,062, a molded decorative plaque including a body portion of a plastic material and a facing sheet disposed over the front face of the body portion is produced by injection molding. The thermoplastic is injected into a mold on a rear side of the facing sheet. As to U.S. Pat. No. 6,117,384, a printed substrate with at least one color is fit into a mold and then a molten resin is injected into the mold cavity through gates behind the printed substrate to produce a one-piece permanently bonded three-dimensional product. In the U.S. Pat. No. 4,391,954, a thermoplastic molding composition comprising an aromatic carbonate polymer and a polyester derived from a cycleohexanedimethanol is revealed. The U.S. Pat. No. 6,465,102 reveals an article that includes formed polymeric base with a decorative surface area and a process for making the molded structure. The polymeric base comprises a transparent cycloaliphatic polyester resin that is free from an aromatic moiety and the method of molding thereof. In the U.S. Pat. No. 6,117,384, an improved in-mold decorating process (IMD) for the manufacture of plastic articles is disclosed while the U.S. Pat. No. 6,136,441 reveals techniques related to multilayer plastic articles. Refer to the patents that reveal structure design or manufacturing method related to the plastic housing mentioned above, it is learned that most of the techniques place a further limitation on the IMD film and the resin base respectively. For example, the IMD film or the resin base is restricted to be made from plastic with a specific chemical group. Thus an integral composite plastic board in which the film and the base are connected firmly and difficult to peel off is produced. Each patent is distinctive other patents.

However, when the IMD film and/or the resin base of the plastic housing formed by composite materials are/is placed with a further limitation, not only the materials used are restricted, the applications of the IMD film and/or the resin base are also limited. This has negative effect on the applications of the produced plastic housing. For example, once users want to use different materials as the IMD film such as fabric, leather, resin fiber, etc for diversity of products, the same technique or equipment is unable to be used for manufacturing the products with high production efficiency, ease in mass production, and good quality control. Thus the use efficiency and application of the plastic housing is unable to be improved. These are disadvantages of the plastic housing.

As to the metal housing, it is generally produced by machining of a metal sheet such as aluminum alloy sheet. The metal housing can be further treated by surface processing to have gloss or patterns. Moreover, a protective resin layer such as resin film is arranged over the outer surface of the metal housing to avoid damages in use such as scratches, bumps, etc. Or a resin layer with figures is arranged at the outer surface of the metal housing for protecting and improving the appearance or texture of the product. For assembling components inside the product, plastic injection molding technique or injection molding attachment is used to dispose or attach various plastic components such as flange or rib on a certain position of an inner surface of the metal housing. Thus the structure of these plastic components is simplified, the whole thickness is reduced and the structural strength is improved.

There are various techniques related to the structure design and manufacturing method of the metal housing mentioned above available now, including U.S. Pat. No. 5,695,699, No. 5,472,782, US App. Pub. No. US2009/0117401, US2008/0127479, US2007/0218721, etc.

Refer to Chinese Pat. App. No. ZL02805359.1 (PCT/JP2002/007267, W02003/064150), a composite material of aluminum alloy and resin and a production method therefore are revealed. As a pre-treatment, a rib is immersed in at least one aqueous solution selected from ammonia, hydrazine, hydrazine derivative and water-soluble amine compound. Then the rib is inserted into an injection molding die used to inject it. A thermoplastic resin composition is filled in the surface of a metal frame by injection molding to form a rib. A molded cover enclosure includes integrally joined metal frame and ribs of a thermoplastic resin composition and having the features of metal in terms of strength and external design. Moreover, the interior of the enclosure can be produced with complicated shape and structure.

Refer to Chinese Pat. App. No. ZL200380102886.0 (PCT/JP2003/014213, W02004/041532), a composite article of aluminum alloy with resin and a method for production thereof are revealed. The composite article includes a thermoplastic resin composition containing polyphenylene sulfide as a component and adhered to the surface of a shaped article of an aluminum alloy. The method includes a pretreatment comprising immersing the shaped article of an aluminum alloy in an aqueous solution of at least one selected from among ammonia, hydrazine and a water-soluble amine compound.

Refer to Chinese Pat. App. No. ZL200380104500.X (PCT/JP2003/014214, WO2004/041533), a composite of aluminum alloy and resin composition and a process for producing the same are revealed. The composite is characterized by comprising an aluminum alloy shaped item having a surface roughness of 5 to 50 μm or more, the surface provided with 1 μm or less fine depressions or protrusions, and a thermoplastic resin composition composed mainly of a polyphenylene sulfide or polybutylene terephthalate resin whose average of lengthwise and crosswise linear expansion coefficients is in the range of 2 to 4×10⁻⁵° C.⁻¹. The thermoplastic resin composition penetrating and anchored in the depressions or protrusions.

Refer to Chinese Pat. App. No. ZL200680046075.7 (PCT/JP2006/324493, WO2007/066742), an aluminum alloy-resin composite and a method of producing the same are revealed. The composite is formed by an aluminum alloy-based material and resin component. An aluminum alloy-based material is dipped in a corrosive aqueous solution such as ammonia, hydrazine, or water-soluble amine compounds to form microconcaves coating the surface. The average radius of the microconcaves is ranging from 10 nm to 80 nm. As the resin component, it includes polyamide resin compounded and a material having improved shock resistance. The aluminum alloy-based material is inserted into an injection molding die and the polyamide-based resin composition is injected onto the surface thereof to give an integrated composite product.

However, the above patents all relate to a composite material formed by metal and resin and a manufacturing method thereof and feature on that the metal (such as aluminum alloy) is immersed in a special aqueous solution (such as water-soluble amine). Then thermoplastic resin with specific ingredients is attached and integrated to a surface of the aluminum alloy by injection molding. In other words, the treatment of the metal (aluminum alloy) and the ingredients of the resin are both specified and restricted. Thus the manufacturing method and the application of the composite material are limited. This has negative effect on use efficiency and application of the metal housing. Especially most of the specific aqueous solution used doesn't match environmental requirements. This is a shortcoming of the above composite material and the metal housing.

As to Taiwanese Pat. App. No. 85100575 (Pub. No 404888), a metal sheet covered by resin and having high distinctness of image and excellent adhesion during processing is revealed. A metal sheet is used as a substrate and is covered by resin. At one side of the substrate, a coating layer, a modified acrylic resin layer with a thickness of 5˜100 μm, a patterned and/or printed layer, an adhesive layer, and a polyester-based resin film with a thickness of 5˜100 μm arranged in sequence therefrom. The modified acrylic resin layer is formed by polypropylene copolymer 100˜20 parts by weight and polypropylene 100˜0 parts by weight. Or the substrate is disposed with a coating layer, a patterned and/or printed layer, a modified acrylic resin layer with a thickness of 5˜100 μm, an adhesive layer, and a polyester-based resin film with a thickness of 5˜100 μm in turn. Or the substrate is installed with a coating layer, a modified acrylic resin layer with a thickness of 5˜100 μm, an adhesive layer, and a polyester-based resin film with a thickness of 5˜100 μm in turn. Or the substrate is set with a coating layer, a modified alkene layer with a thickness of 5˜100 μm, and a transparent polyester-based resin film with a thickness of 5˜100 μm in sequence. However, the ingredients of the laminated resin layer have been specified and limited and the main purpose is to make the metal sheet covered by the resin have high distinctness of image. Thus the shape of the metal sheet is also limited and this has negative effect on the application of the metal housing produced by the metal sheet.

Refer to Taiwanese Pat. App. No. 86106332 (Pub. No. 434145) “metal sheet coated with resin and having higher definition, reflectivity and good adhesion”, a metal sheet covered with resin is revealed. The metal sheet covered with resin includes a metal sheet used as a base, a transparent soft resin layer, an adhesive layer with pigments, a transparent resin film having two sides with gloss finish. The arithmetic mean deviation Ra of the roughness of the metal sheet is between 0 and 10 micrometers. The transparent soft resin layer can be uncured mixed type resin layer, coating cover layer made from polyester resin, or polyolefin resin. At least one surface of the metal sheet is covered by a coloring layer, the soft resin layer, the adhesive layer and the transparent layer in turn from the metal sheet to the transparent resin film. However, the ingredients of the resin coated the metal sheet are limited and the main purpose is to make the metal sheet covered by the resin have high reflectivity. Thus the shape of the metal sheet is also limited and this has negative effect on the application of the metal housing produced by the metal sheet.

Refer to Taiwanese Pat. App. No. 093119015 (Pat. Grant No. 1280190) “method for forming electronic metal housing and structure of the same”, an aluminum alloy substrate disposed with a film layer focused on improvement of shortcomings of two prior arts is revealed. The method includes a step of coating adhesive, a step of firing and heating, a step of rolling and pressing and a step of cooling and forming. Firstly, coat adhesive on a surface of at least one side of a metal substrate made from aluminum alloy and the adhesive has metal powders. Then heat the metal substrate coated with the adhesive to make the adhesive become soft. A film layer is rolled and pressed over the adhesive by a heated roller. The film layer consists of at least one polyvinylchloride (PVC) layer, an adhesive layer, and a polyester layer laminated to each other in turn. The adhesive layer also includes metal powders. After cooling, the film layer and the metal substrate are connected to each other tightly. However, the ingredients of the film layer laminated on the surface of one side of the aluminum metal substrate including the PVC layer, the adhesive layer, and the polyester layer arranged in turn are specified and limited. Thus the shape of the metal substrate is restricted and this has negative effect on the application of the electronic metal housing.

Refer to Taiwanese Pat. App. No. 097208521 (Pat. Grant No. M345706) “composite metal sheet”, a composite metal sheet including a metal substrate, a composite resin adhesive layer and a pressed layer laminated on a metal sheet over the composite resin adhesive layer. Thus the metal sheet and the metal substrate are connected with each other tightly. However, the two outer sides of this invention include the metal sheet and the metal substrate, both are being specified and restricted.

Refer to Taiwanese Pat. App. No. 096215339 (Pat. Grant No. M328384) “metal with environmental protection laminate”, the metal with the environmental protection laminate includes at least one metal substrate, an adhesive layer coated on at least one surface of one side of the substrate, and a film layer formed by a polyurethane (PU) bottom layer and a PU surface layer. The adhesive layer can be softened by being heated. A roller is used to roll and press the film layer on the adhesive layer. Then after cooling, the film layer and the metal substrate are connected firmly. However, the film layer formed by the PU bottom layer and the PU surface layer has been specified and defined. Thus the appearance or texture of the metal substrate is restricted and this is bad for the application of the metal housing produced by the metal with the film.

Thus the techniques available for composite boards have certain shortcomings. There is room for improvement and a need to provide a novel structure of the composite board and a method for manufacturing the same.

### SUMMARY OF THE INVENTION

Therefore it is a primary object of the present invention to provide a composite board formed by a metal substrate connected to a decorative outer layer and a method for manufacturing the same. The composite board includes a metal substrate, a first thermoplastic rubber (TPR) adhesive layer, a second TPR adhesive layer and a decorative outer layer arranged in sequence. In the composite board and the method for manufacturing the same of the present invention, the second TPR adhesive layer is infiltrated into existing micro holes on surface of the decorative outer layer and also connected to the first TPR adhesive layer tightly by hot press laminating. Thus the second. TPR adhesive layer will not peel off easily. The composite board formed can be treated by deep-processing and forming operation such as deep drawing, drawing, cutting, etc. according to design requirements so as to produce a housing with both good strength and beautiful appearance. Thus the shortcomings of prior arts including low adhesion strength, poor forming quality and restrictions on materials used for the decorative outer layer can be overcome.

It is another object of the present invention to provide a composite board formed by a metal substrate connected to a decorative outer layer and a method for manufacturing the same in which the decorative outer layer can be made from different materials such as fabric, natural leather, synthetic leather, natural fiber or synthetic resin fiber, etc. Thus the housing produced by the composite board has various patterns and/or texture. The product styles are increased and consumers have more options. Both the value and the competitiveness of products are improved. On the other hand, in previous techniques, the decorative outer layer made from different materials needs different equipment to produce the composite board. This is not cost-effective. The present invention features on high production efficiency, ease in mass production, durability in deep drawing and good control of forming quality.

In order to achieve the above objects, the metal substrate is a metal sheet with a certain thickness and having a plurality of micro concave holes disposed on surface thereof and distributed evenly. The micro concave holes are generated naturally on the surface during forming and manufacturing process of the metal substrate.

The first TPR adhesive layer is a thermoplastic rubber layer synthesized by butadiene-styrene block copolymer and hydrocarbon petroleum resin. The thickness of the first TPR adhesive layer is 400-500 μm. The first TPR adhesive layer is laminated on the surface on one side of the metal substrate by hot press that applies heat and pressure simultaneously with a roller or a board. A part of the first TPR adhesive layer is infiltrated into the micro concave holes on the surface of the metal substrate during the hot press laminating.

The second TPR adhesive layer is a thermoplastic rubber layer synthesized by butadiene-styrene block copolymer and hydrocarbon petroleum resin. The thickness of the second TPR adhesive layer is 400-500 μm. The second TPR adhesive layer is attached to the surface on one side of the decorative outer layer.

The decorative outer layer is a film used for decoration with a plurality of micro holes distributed evenly on the surface thereof. The micro holes are generated naturally during forming and manufacturing process of the decorative outer layer.

The metal substrate and the decorative outer layer are connected to each other by a hot pressing laminating process so as to form a composite board.

During the hot press laminating processing of the metal substrate and the decorative outer layer, the first TPR adhesive layer and the second TPR adhesive layer therebetween are melted and connected to each other simultaneously. A part of the second TPR adhesive layer with a certain thickness is also infiltrated into the existing micro holes on the surface of the decorative outer layer. Thus the decorative outer layer is connected to the surface on one side of the metal substrate by the second TPR adhesive layer and the first TPR adhesive layer adhered with each other firmly. The adhesion strength thereof allows deep processing without peeling of the decorative outer layer.

The metal substrate is an aluminum alloy sheet.

The decorative outer layer is a fabric layer made from natural fiber such as vegetable fiber, animal fiber, or artificial fiber. The vegetable fiber can be cotton, hemp, etc., the animal fiber can be wool, silk, etc. and the artificial fiber includes nylon, polyester, acrylic fiber, etc. The decorative outer layer can also be a leather layer made from natural leather such as sheep skin, cowskin, etc. or synthetic leather formed by PU, PVC, or PU together with PVC. Or the decorative outer layer is a bamboo layer formed by laminated bamboo sheet. Or the decorative outer layer is a wood layer formed by laminated wood sheet.

A part (about 10%) of the first TPR adhesive layer with the thickness of 40-50 μm is infiltrated into the micro concave holes mentioned above on the surface of the metal substrate during the hot press laminating process.

The method for manufacturing a composite board formed by a metal substrate connected to a decorative outer layer of the present invention includes following steps.

Firstly, provide a metal substrate with a certain thickness. There is a plurality of micro concave holes formed naturally along with manufacturing and forming of the metal substrate and distributed evenly on a surface of the metal substrate.

Then hot press laminate a first TPR (thermoplastic rubber) adhesive layer with a thickness of 400-500 μm on a surface of one side of the metal substrate by simultaneous application of heat and pressure with a roller or a board passing over. The TPR adhesive layer is a thermoplastic rubber film synthesized by butadiene-styrene block copolymer and hydrocarbon petroleum resin. A part (10%) of the first TPR adhesive layer with the thickness of 40-50 μm is infiltrated into the existing micro concave holes on the surface of the metal substrate.

Next provide a decorative outer layer with a certain thickness and having plurality of micro holes naturally produced and distributed evenly on a surface thereof along with manufacturing and forming of the decorative layer.

Attach a second TPR adhesive layer with a thickness of 400-500 μm to a surface of the decorative outer layer by being heated with a roller. The second TPR adhesive layer is a thermoplastic rubber film synthesized by butadiene-styrene block copolymer and hydrocarbon petroleum resin.

At last, perform a hot press laminating process to the metal substrate and the decorative outer layer to make the metal substrate and the decorative outer layer attach and connect each other tightly through the first and the second TPR adhesive layers on their surfaces. Moreover, the second TPR adhesive layer is infiltrated into the existing micro holes on the surface of the decorative outer surface and also connected to the first TPR adhesive layer firmly simultaneously during the hot press laminating process.

After cooling, an integral composite board including the metal substrate and the decorative outer layer is formed.

The metal substrate is an aluminum alloy sheet.

The decorative outer layer is made from fabric, leather, bamboo or wood. The fabric layer is formed by natural or artificial fiber. The leather can be natural leather or synthetic PU/PVC leather. The bamboo layer is formed by laminated bamboo sheet. The wood layer is formed by laminated wood sheet.

The hot press laminating process further includes a process of firing and heating. The first TPR adhesive layer on the surface of the metal substrate is fired and heated to increase its temperature up to 130° C. Thus the first TPR adhesive layer becomes soft and this is beneficial to the hot press laminating process.

The hot press laminating process further includes a process of firing and heating. The second TPR adhesive layer on the surface of the decorative outer layer is fired and heated to increase its temperature up to 130° C. Thus the second TPR adhesive layer becomes soft and this is beneficial to the hot press laminating process.

The hot press laminating process is performed by a heated roller. The temperature of the heated roller is maintained at 140° C. The heated roller is used to press and laminate the decorative outer layer to the first TPR adhesive layer on the metal substrate through the second TPR adhesive layer so as make the decorative outer layer and the metal substrate connect to each other firmly.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flow chart showing steps of a method for manufacturing a composite board according to the present invention;

FIG. 2 is a partial enlarged view of a cross section of a composite board according to the present invention;

FIG. 3 is a perspective view of a housing formed by drawing and pressing of a composite board according to the present invention;

FIG. 4 is a schematic drawing showing a rear view of the embodiment in FIG. 3.

### DETAILED DESCRIPTION OF THE PREFERRED EMBODIMENT

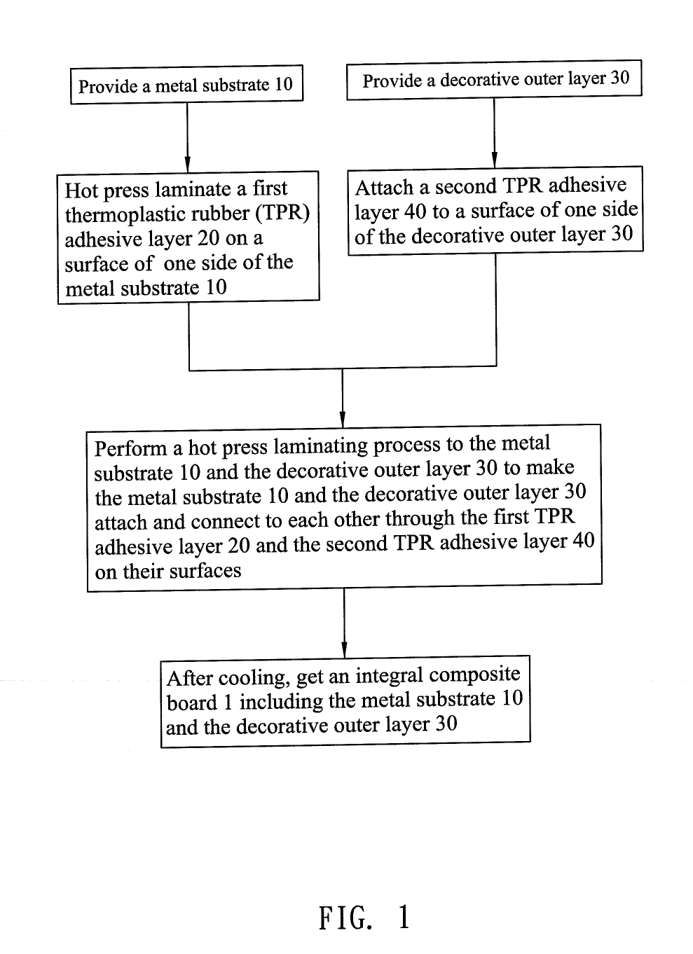

Refer to FIG. 1, a schematic drawing showing steps of a method for manufacturing a composite board according to the present invention is revealed. The method for manufacturing a composite board 1 of the present invention mainly includes a plurality of steps.

Firstly, provide a metal substrate 10 with proper thickness. The metal substrate 10 can be but not limited to an aluminum alloy sheet that is produced by common forming techniques and having a plurality of micro concave holes distributed evenly on a surface thereof.

Hot press/laminate a first TPR (thermoplastic rubber) adhesive layer with a thickness of 400-500 μm (μm=10⁻⁶ m) on a surface of at least one side of the metal substrate 10. The hot press laminating is achieved by simultaneous application of heat and pressure with a roller or a board passing over. The TPR adhesive layer is a thermoplastic rubber film synthesized by butadiene-styrene block copolymer and hydrocarbon petroleum resin. A part (10%) of the thickness of the first TPR adhesive layer 20 with the thickness of 40-50 μm is infiltrated into the existing micro concave holes on the surface of the metal substrate 10.

Then provide a decorative outer layer 30 with a certain thickness. The decorative outer layer 30 includes but not limited to at least one of the following: a fabric layer formed by natural or artificial fiber, a leather layer formed by natural or PU (Polyurethane)/PVC (polyvinyl chloride) synthetic leather, a bamboo layer formed by laminated bamboo sheet, or a wood layer formed by laminated wood sheet, etc. Moreover, there is a plurality of micro concave holes generated naturally along with manufacturing and formation of the decorative outer layer 30 and distributed evenly on a surface of the decorative outer layer 30.

A second TPR adhesive layer 40 with a thickness of 400-500 μm is heated by a roller with no pressure or applied with only a little pressure so as to be attached to a surface of the decorative outer layer 30. The second TPR adhesive layer 40 is not infiltrated into the micro concave holes on the surface of the decorative outer layer 30.

Next perform a hot press laminating process to the metal substrate 10 and the decorative outer layer 30 to make the metal substrate 10 and the decorative outer layer 30 attach and connect to each other through the first TPR adhesive layer 20 and the second TPR adhesive layer 40 on their surfaces. Moreover, the second TPR adhesive layer 40 is infiltrated into the existing micro concave holes on the surface of the decorative outer layer 30 and is connected to the first TPR adhesive layer 20 of the metal substrate 10 tightly during the hot press laminating process.

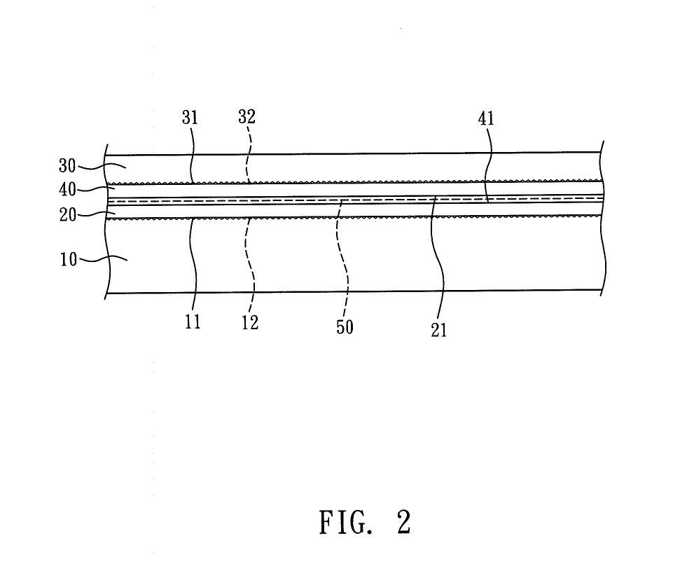

After cooling, an integral composite board 1 including the metal substrate 10 and the decorative outer layer 30 is formed, as shown in the FIG. 2.

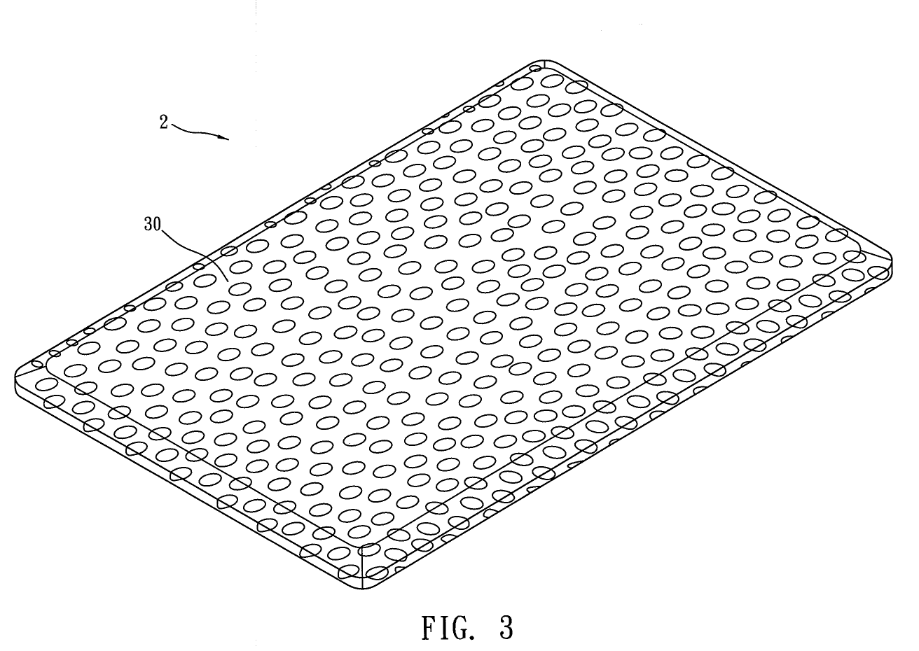

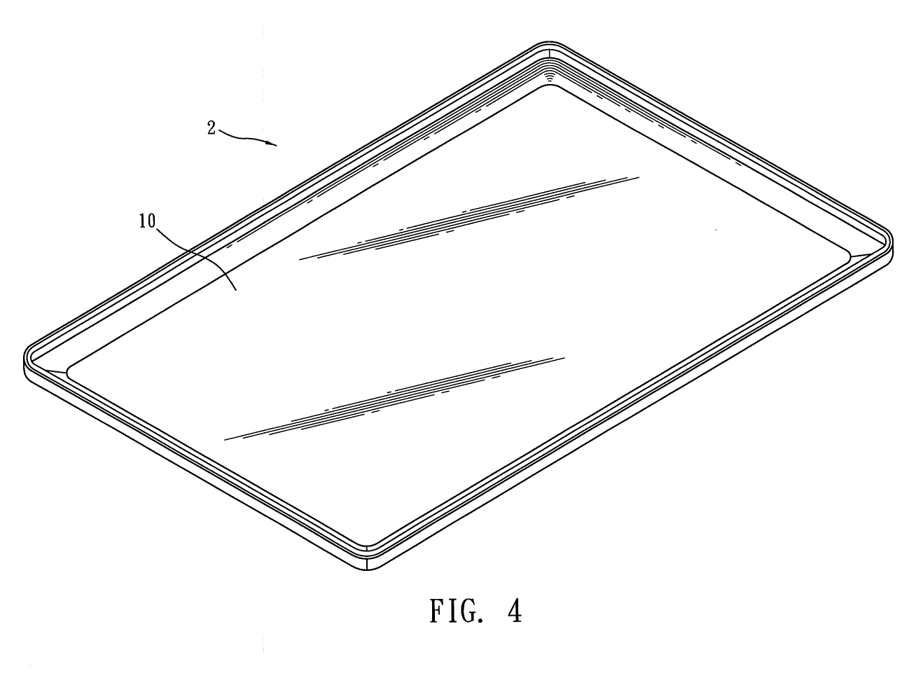

According to the method of the present invention mentioned above, the connection between the metal substrate 10 and the decorative outer layer 30 of the produced composite board 1 provides good adhesion due to the second TPR adhesive layer 40 infiltrated into the existing concave holes on the surface of the decorative outer layer 30 and simultaneously melted and connected to the first TPR adhesive layer 20 of the metal substrate 10 during the hot press laminating process. After being tested, the composite board 1 is strong enough to receive the following deep-processing and forming operation such as deep drawing, drawing, cutting, etc. Thus the composite board 1 of the present invention can be processed by deep drawing according to design requirements to form a housing 2 with good strength and beautiful appearance, as shown in FIG. 3 and FIG. 4. And the shortcomings of the prior arts including low adhesion strength, poor forming quality and restrictions on materials used for the decorative outer layer can be overcome.

The manufacturing method of the present invention meets the requirements of environmental protection techniques available now. In the present invention, a plurality of micro concave holes is formed naturally during the molding and manufacturing process and distributed evenly on the surface of the metal substrate 10. A part of the first TPR adhesive layer 20 with a certain thickness is directly infiltrated into the micro concave holes during the step of hot pressing.

Thus there is no need to use any special aqueous solution or any step of soaking the metal substrate into special aqueous solution for forming a plurality of concave parts with a certain depth or inner diameter on the surface of the metal substrate. The concave parts are used to allow thermoplastic resin with special ingredients forming and attaching to the surface of the metal substrate, as techniques revealed in Chinese Pat. No. ZL02805359.1, ZL200380102886.0, ZL200380104500.X and ZL200680046075.7, etc.

In the above method, before hot-pressing of the first TPR adhesive layer 20 on surface of the metal substrate 10, a cleaning process is performed according to the surface condition of the metal substrate 10. The cleaning process includes but not limited to debinding, forcefully brushing etc. The main purpose of this step is to keep cleanness of the surface of the metal substrate 10 at a certain degree for preventing any negative effects on the following hot pressing of the first TPR adhesive layer 20. Thus the tight connection between the first TPR adhesive layer 20 and the surface of the metal substrate 10 is ensured.

In the above method, the hot press laminating process that connects the decorative outer layer 30 and the metal substrate 10 tightly further includes but not limited to the following process: a firing and heating process before performing the hot press laminating. The first TPR adhesive layer 20 disposed on the surface of the metal substrate 10 is fired and heated to about 130 degrees Celsius and melted. This is beneficial to hot press laminate the first TPR adhesive layer 20 onto the second TPR adhesive layer 40 on the surface of the decorative outer layer 30. Moreover, perform another firing and heating process on the second TPR adhesive layer 40 arranged at the surface of the decorative outer layer 30. The second TPR adhesive layer 40 is heated to about 130 degrees Celsius and melted. Then perform a hot press laminating process for connecting the second TPR adhesive layer 40 to the first TPR adhesive layer 20 disposed on the surface of the metal substrate 10.

In the above method, a heated roller is used to perform the hot press laminating process. The temperature of the roller is kept at about 140 degrees Celsius so as to laminate the decorative outer layer 30 over the first TPR adhesive layer 20 of the metal substrate 10 through the second TPR adhesive layer 30. Thus the integral composite board 1 including the decorative outer layer 30 and the metal substrate 10 is formed by melting properties of the first and the second TPR adhesive layers 20, 40.

Refer to FIG. 2, a cross sectional view of the composite board 1 is revealed. The integral composite board 1 includes a metal substrate 10, a first TPR adhesive layer 20, a second TPR adhesive layer 40, and a decorative outer layer 30, etc.

The metal substrate 10 is made from metal that can form a housing 2 of an electronic device. The housing 2 can be, but not limited to, a housing of a 3C product such as a computer product, a communication product, or a consumer product, as shown in FIG. 3 and FIG. 4. Generally, a lightweight metal with high strength such as aluminum alloy sheet is used. A surface 11 of the metal substrate 10 is arranged with a plurality of micro concave holes 12 (the concave hole 12 in the figure is enlarged) distributed or covered evenly. The micro concave holes 12 are formed naturally during the forming process of the metal substrate 10 such as rolling molding, not formed by using any specific aqueous solution or other special processing such as soaking the metal substrate 10 into special aqueous solution.

The first TPR adhesive layer 20 is a thermoplastic rubber film synthesized by butadiene-styrene block copolymer and hydrocarbon petroleum resin. The material composition of the first TPR adhesive layer 20 including types and percentage of main ingredients can be different, such as a thin film of thermoplastic a thin film of TPU/TPE which is a kind of thermoplastic elastomer with the thickness of about 400-500 μm (1 μm=10⁻⁶ m). The first TPR adhesive layer 20 is connected to and integrated with a surface 11 on at least one side of the metal substrate 10 by hot pressing that is achieved by simultaneous application of heat and pressure with a roller or a board passing over. Moreover, a part of the first TPR adhesive layer 20 with a thickness of 40-50 μm, about 10% of the original thickness, can be infiltrated into the existing micro concave holes 12 on the surface 11 of the metal substrate 10 during the hot pressing process. Peeling or breakage during the deep drawing can be avoided by increasing the adhesion strength between the first TPR adhesive layer 20 and the metal substrate 10. An outer side of the first TPR adhesive layer 20 is shown as an interface 21.

The second TPR adhesive layer 40 is a thermoplastic rubber layer synthesized by butadiene-styrene block copolymer and hydrocarbon petroleum resin. The materials can be totally the same with those of the first TPR adhesive layer 20. Or the types of the ingredients are the same but the percentage of the ingredients are different. The second TPR adhesive layer 40 can be a thin film of TPU/TPE which is a kind of thermoplastic elastomer with the thickness of about 400-500 μm. The second TPR adhesive layer 40 is heated by a roller with no pressure or applied with only a little pressure so as to be attached to a surface 31 of the decorative outer layer 30. The second TPR adhesive layer 40 is not infiltrated into the micro concave holes on the surface of the decorative outer layer 30. However, during the laminating process, the roller is only heating with no pressure or only a little pressure. Thus the second TPR adhesive layer 40 is not infiltrated into the existing micro concave holes 32 on the surface 31 of the decorative outer layer 30 during the hot pressing process. That means the second TPR adhesive layer 40 is not infiltrated into the existing micro concave holes 32 on the surface 31 of the decorative outer layer 30 before the hot pressing laminating process performed between the metal substrate 10 and the decorative outer layer 30. An outer side of the second TPR adhesive layer 40 is indicated as an interface 41.

Moreover, the composite board 1 shown in FIG. 3 is formed by the hot pressing laminating process. At this moment, the metal substrate 10 and the decorative outer layer 30 are already connected and attached to each other through the first and the second adhesive layers 20, 40 that are melted and connected to each other. Thus the original interface 21/41 of the first/second TPR adhesive layer 20/40 disappears. A dotted line 50 in FIG. 2 is used to show melted and connected state of the original interface 21/41.

The decorative outer layer 30 includes but not limited to at least one material selected from the group consisting of a fabric layer, a leather layer, a bamboo layer, and a wood layer. The fabric layer is formed by vegetable fiber such as cotton, hemp, etc., animal fiber such as wool, silk, etc. or artificial fiber including nylon, polyester, acrylic fiber, etc. The leather layer is produce by natural leather or PU (Polyurethane)/PVC (polyvinyl chloride) synthetic leather. The bamboo layer is composed of laminated bamboo sheet. The wood layer is formed by laminated wood sheet. The decorative outer layer 30 can be processed according to users needs to have different surface patterns or texture. Moreover, the surface 31 of the decorative outer layer 30 naturally includes a plurality of micro concave holes 32 distributed evenly and formed along with production of the decorative outer layer 30. The micro concave holes 32 can be meshes of the natural/artificial fiber or pores of natural leather. During the hot pressing laminating process of the metal substrate 10 and the decorative outer layer 30, the second TPR adhesive layer 40 can also be infiltrated into the existing micro concave holes 32 on the surface 31 of the decorative outer layer 30. Thus the decorative outer layer 30 is tightly attached to the surface on one side of the metal substrate 10 by the second TPR adhesive layer 40 and the first TPR adhesive layer 20. The tight adhesion allows deep-processing without peeling.

The structure and the function of the composite board 1 of the present invention are revealed through following embodiments in which the metal substrate 10 is made from aluminum alloy sheet and the decorative outer layer 30 is made from various materials.

### Embodiment One

In this embodiment, a composite board 1 includes a metal substrate 10 and a decorative outer layer 30. The metal substrate 10 is an aluminum alloy sheet with a thickness of 0.8 mm. A first TPR adhesive layer 20 intended to be disposed on the surface of the metal substrate 10 is a thermoplastic rubber film synthesized by butadiene-styrene block copolymer and hydrocarbon petroleum resin. The thickness of the first TPR adhesive layer 20 is ranging from 400 to 500 μm. After the first TPR adhesive layer 20 being hot pressed on the aluminum alloy sheet 10 by simultaneous application of heat and pressure with a roller or a board, its thickness is changed to about 360-450 μm.

The decorative outer layer 30 is a fabric layer made from natural fiber including vegetable fiber such as cotton, hemp, etc. or animal fiber such as wool, silk, etc. and with the thickness of 0.3 mm. A second TPR adhesive layer 40 arranged at a surface of the decorative outer layer 30 is a thermoplastic rubber film synthesized by butadiene-styrene block copolymer and hydrocarbon petroleum resin. The thickness of the second TPR adhesive layer 40 is ranging from 400 to 500 μm.

After a hot pressing laminating process of the metal substrate 10 and the decorative outer layer 30, the thickness of the composite board 1 formed is 1.1 mm.

The test results show that the peel strength adhesion of this embodiment is 5 kg/cm². In the environmental testing with adhesion testing, the operating temperature range is from −40° C. to 85° C. and the temperature is increasing/decreasing 1° C. each min within the range of −40° C.-85° C. and there are four cycles. The housing formed by the composite board is shown in FIG. 3 and FIG. 4. The decorative outer layer 30 is not peeled off from the aluminum alloy sheet 10.

### Embodiment Two

A composite board 1 of this embodiment includes a metal substrate 10 and a decorative outer layer 30. The metal substrate 10 is an aluminum alloy sheet with a thickness of 0.8 mm. A first TPR adhesive layer 20 intended to be disposed on the surface of the metal substrate 10 is a thermoplastic rubber film synthesized by butadiene-styrene block copolymer and hydrocarbon petroleum resin. In the beginning, the thickness of the first TPR adhesive layer 20 is ranging from 400 to 500 μm. Then the thickness of the first TPR adhesive layer 20 is changed to about 360-450 μm after it is hot pressed on the aluminum alloy sheet 10 by simultaneous application of heat and pressure with a roller or a board.

The decorative outer layer 30 is a fabric layer made from artificial fiber including nylon, polyester fiber, acrylic fiber etc. and with the thickness of 0.3 mm. A second TPR adhesive layer 40 arranged at a surface of the decorative outer layer 30 is a thermoplastic rubber film synthesized by butadiene-styrene block copolymer and hydrocarbon petroleum resin. The thickness of the second TPR adhesive layer 40 is about 400-500 μm.

The thickness of the composite board 1 formed after a hot pressing laminating process is 1.1 mm.

The test results of this embodiment show that the peel strength adhesion is 5 kg/cm². In the environmental testing with adhesion testing, the operating temperature range is from −40° C. to 85° C. and the temperature is increasing/decreasing 1° C. each min within the range of −40° C.-85° C. and there are four cycles. The housing formed by the composite board is shown in FIG. 3 and FIG. 4. The decorative outer layer 30 is not peeled off from the aluminum alloy sheet 10.

### Embodiment Three

A composite board 1 of this embodiment includes a metal substrate 10 and a decorative outer layer 30. The metal substrate 10 is an aluminum alloy sheet with a thickness of 0.8 mm. A first TPR adhesive layer 20 intended to be arranged at the surface of the metal substrate 10 is a thermoplastic rubber film synthesized by butadiene-styrene block copolymer and hydrocarbon petroleum resin. The thickness of the first TPR adhesive layer 20 is ranging from 400 to 500 μm. After the first TPR adhesive layer 20 being hot pressed on the aluminum alloy sheet 10 by simultaneous application of heat and pressure with a roller or a board, its thickness is changed to about 360-450 μm.

The decorative outer layer 30 is a natural sheep leather and with the thickness of 0.4 mm. A second TPR adhesive layer 40 disposed on a surface of the decorative outer layer 30 is a thermoplastic rubber film synthesized by butadiene-styrene block copolymer and hydrocarbon petroleum resin. The thickness of the second TPR adhesive layer 40 is about 400-500 μm.

The thickness of the composite board 1 formed after a hot pressing laminating process is 1.2 mm.

The test results of this embodiment show that the peel strength adhesion is 5 kg/cm². In the environmental testing with adhesion testing, the operating temperature range is from −40° C. to 85° C. and the temperature is increasing/decreasing 1° C. each min within the range of −40° C.-85° C. and there are four cycles. The housing formed by the composite board is shown in FIG. 3 and FIG. 4. The decorative outer layer 30 is not peeled off from the aluminum alloy sheet 10.

### Embodiment Four

A composite board 1 of this embodiment includes a metal substrate 10 and a decorative outer layer 30. The metal substrate 10 is an aluminum alloy sheet with a thickness of 0.8 mm. A first TPR adhesive layer 20 intended to be arranged at the surface of the metal substrate 10 is a thermoplastic rubber film synthesized by butadiene-styrene block copolymer and hydrocarbon petroleum resin. The thickness of the first TPR adhesive layer 20 is ranging from 400 to 500 μm. But the thickness of the first TPR adhesive layer 20 is changed to about 360-450 μm after it is hot pressed on the aluminum alloy sheet 10 by simultaneous application of heat and pressure with a roller or a board.

The decorative outer layer 30 is formed by PU/PVC synthetic leather with the thickness of 0.5 mm. A second TPR adhesive layer 40 disposed on a surface of the decorative outer layer 30 is a thermoplastic rubber film synthesized by butadiene-styrene block copolymer and hydrocarbon petroleum resin. The thickness of the second TPR adhesive layer 40 is about 400-500 μm.

The thickness of the composite board 1 formed after a hot pressing laminating process is 1.3 mm.

The test results show that the peel strength adhesion of this embodiment is 5 kg/cm². In the environmental testing with adhesion testing, the operating temperature range is from −40° C. to 85° C. and the temperature is increasing/decreasing 1° C. each min within the range of −40° C.-85° C. and there are four cycles. The housing formed by the composite board is shown in FIG. 3 and FIG. 4. The decorative outer layer 30 is not peeled off from the aluminum alloy sheet 10.

### Embodiment Five

In this embodiment, a composite board 1 includes a metal substrate 10 and a decorative outer layer 30. The metal substrate 10 is an aluminum alloy sheet with a thickness of 0.8 mm. A first TPR adhesive layer 20 intended to be disposed on the surface of the metal substrate 10 is a thermoplastic rubber film synthesized by butadiene-styrene block copolymer and hydrocarbon petroleum resin. The thickness of the first TPR adhesive layer 20 is ranging from 400 to 500 μm. After the first TPR adhesive layer 20 being hot pressed on the aluminum alloy sheet 10 by simultaneous application of heat and pressure with a roller or a board, its thickness is changed to about 360-450 μm.

The decorative outer layer 30 is formed by laminated bamboo sheet with the thickness of 0.4 mm. A second TPR adhesive layer 40 disposed on a surface of the decorative outer layer 30 is a thermoplastic rubber film synthesized by butadiene-styrene block copolymer and hydrocarbon petroleum resin. The thickness of the second TPR adhesive layer 40 is about 400-500 μm.

The thickness of the composite board 1 formed after a hot pressing laminating process is 1.2 mm.

The test results of this embodiment show that the peel strength adhesion is 5 kg/cm². In the environmental testing with adhesion testing, the operating temperature range is from −40° C. to 85° C. and the temperature is increasing/decreasing 1° C. each min within the range of −40° C.-85° C. and there are four cycles. The housing formed by the composite board is shown in FIG. 3 and FIG. 4. The decorative outer layer 30 is not peeled off from the aluminum alloy sheet 10.

### Embodiment Six

In this embodiment, a composite board 1 includes a metal substrate 10 and a decorative outer layer 30. The metal substrate 10 is an aluminum alloy sheet with a thickness of 0.8 mm. A first TPR adhesive layer 20 intended to be disposed on the surface of the metal substrate 10 is a thermoplastic rubber film synthesized by butadiene-styrene block copolymer and hydrocarbon petroleum resin. The thickness of the first TPR adhesive layer 20 is ranging from 400 to 500 μm. After the first TPR adhesive layer 20 being hot pressed on the aluminum alloy sheet 10 by simultaneous application of heat and pressure with a roller or a board, its thickness is changed to about 360-450 μm.

The decorative outer layer 30 is formed by laminated wood sheet with the thickness of 0.4 mm. A second TPR adhesive layer 40 disposed on a surface of the decorative outer layer 30 is a thermoplastic rubber film synthesized by butadiene-styrene block copolymer and hydrocarbon petroleum resin. The thickness of the second TPR adhesive layer 40 is about 400-500 μm.

The thickness of the composite board 1 formed after a hot pressing laminating process is 1.2 mm.

The test results show that the peel strength adhesion of this embodiment is 5 kg/cm². In the environmental testing with adhesion testing, the operating temperature range is from −40° C. to 85° C. and the temperature is increasing/decreasing 1° C. each min within the range of −40° C.-85° C. and there are four cycles. The housing formed by the composite board is shown in FIG. 3 and FIG. 4. The decorative outer layer 30 is not peeled off from the aluminum alloy sheet 10.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A composite board formed by a metal substrate connected to a decorative outer layer comprising a metal substrate, a first thermoplastic rubber (TPR) adhesive layer, a second TPR adhesive layer, and an decorative outer layer arranged in sequence; wherein
the metal substrate is a metal sheet with a certain thickness and having a plurality of micro concave holes that is distributed nearly evenly on a surface thereof and is generated naturally during forming and manufacturing of the metal substrate;
the first TPR adhesive layer is a thermoplastic rubber film synthesized by butadiene-styrene block copolymer and hydrocarbon petroleum resin and having a thickness of 400-500 μm; the first TPR adhesive layer is disposed on a surface of one side of the metal substrate by hot press laminating; the hot press laminating is achieved by simultaneous application of heat and pressure with a roller or a board passing over; a part of the first TPR adhesive layer with a certain thickness is infiltrated into the micro concave holes on the surface of the metal substrate during the hot press laminating;
the second TPR adhesive layer is a thermoplastic rubber film synthesized by butadiene-styrene block copolymer and hydrocarbon petroleum resin and having a thickness of 400-500 μm; the second TPR adhesive layer is attached to a surface on one side of the decorative outer layer;
the decorative outer layer is a thin film for decoration and having a plurality of micro holes that is distributed nearly evenly on a surface thereof and is generated naturally during formation and manufacturing of the decorative outer layer;
wherein the metal substrate and the decorative outer layer are hot-pressed and laminated to each other by a hot press laminating process;
wherein during the hot press laminating process of the metal substrate and the decorative outer layer, the first TPR adhesive layer and the second TPR adhesive layer between the metal substrate and the decorative outer layer are also melted and connected to each other while a part of the second TPR adhesive layer with a certain thickness is infiltrated into the plurality of micro holes on the surface of the decorative outer layer so that the decorative outer layer is tightly attached to the surface of one side of the metal substrate through the second TPR adhesive layer and the first TPR adhesive layer, allowing deep processing without peeling off.

2. The composite board as claimed in claim 1, wherein the metal substrate is an aluminum alloy sheet.

3. The composite board as claimed in claim 1, wherein the decorative outer layer is a fabric layer made from natural fiber such as cotton, hemp of vegetable fiber or wool, silk of animal fiber.

4. The composite board as claimed in claim 1, wherein the decorative outer layer is a fabric layer made from artificial fiber including nylon, polyester, and acrylic fiber.

5. The composite board as claimed in claim 1, wherein the decorative outer layer is a leather layer made from natural leather including sheep skin and cowskin.

6. The composite board as claimed in claim 1, wherein the decorative outer layer is a leather layer made from synthetic leather including polyurethane (PU), polyvinyl chloride (PVC), or PU together with PVC.

7. The composite board as claimed in claim 1, wherein the decorative outer layer is a bamboo layer formed by laminated bamboo sheet.

8. The composite board as claimed in claim 1, wherein the decorative outer layer is a wood layer formed by laminated wood sheet.

9. The composite board as claimed in claim 1, wherein 10 percent of the first TPR adhesive layer with a thickness of about 40-50 μm is infiltrated into the plurality of micro concave holes on the surface of the metal substrate during the hot press laminating.

10. A method for manufacturing a composite board formed by a metal substrate connected to a decorative outer layer comprising the steps of:
providing a metal substrate with a certain thickness and having a plurality of micro concave holes that is generated naturally along with manufacturing and forming of the metal substrate and is distributed evenly on a surface of the metal substrate;
hot press laminating a first thermoplastic rubber(TPR) adhesive layer with a thickness of 400-500 μm on a surface of one side of the metal substrate by simultaneous application of heat and pressure with a roller or a board; the TPR adhesive layer is a thermoplastic rubber film synthesized by butadiene-styrene block copolymer and hydrocarbon petroleum resin and about 10% of the first TPR adhesive layer with the thickness of 40-50 μm is infiltrated into the micro concave holes on the surface of the metal substrate during the hot pressing;
providing a decorative outer layer with a certain thickness and having a plurality of micro holes naturally that is generated along with manufacturing and forming of the decorative layer and is distributed evenly on a surface thereof;
attaching a second TPR adhesive layer with a thickness of 400-500 μm to a surface of the decorative outer layer by being heated with a roller; the second TPR adhesive layer is a thermoplastic rubber film synthesized by butadiene-styrene block copolymer and hydrocarbon petroleum resin;
performing a hot press laminating process to the metal substrate and the decorative outer layer to make the metal substrate and the decorative outer layer attach and connect each other tightly through the first and the second TPR adhesive layers on their surfaces; the second TPR adhesive layer is infiltrated into the micro holes on the surface of the decorative outer surface and also connected to the first TPR adhesive layer firmly simultaneously during the hot press laminating process; and
forming an integral composite board including the metal substrate and the decorative outer layer after cooling.

11. The method as claimed in claim 10, wherein the metal substrate is an aluminum alloy sheet.

12. The method as claimed in claim 10, wherein the decorative outer layer is a layer selected from the group consisting of a fabric layer made from natural or artificial fiber, a leather layer made from natural leather of PU/PVC synthetic leather, a bamboo layer made from laminated bamboo sheet, and a wood layer made from laminated wood sheet.

13. The method as claimed in claim 10, wherein the hot press laminating process further includes a process of firing and heating applied to the first TPR adhesive layer so that the first TPR adhesive layer is heated up to about 130° C. and melted and this is beneficial to the hot press laminating process.

14. The method as claimed in claim 10, wherein the hot press laminating process further includes a process of firing and heating applied to the second TPR adhesive layer so that the second TPR adhesive layer is heated up to about 130° C. and melted and this is beneficial to the hot press laminating process.

15. The method as claimed in claim 10, wherein the hot press laminating process is performed by a heated roller whose temperature is maintained at 140° C.; the heated roller is used to press and laminate the second TPR adhesive layer of the decorative outer layer to the first TPR adhesive layer on the metal substrate so as make the decorative outer layer and the metal substrate connect to each other firmly.
